(19) United States
(12) Patent Application Publication
(10) Pub. No.: US 2003/0224100 A1
(43) Pub. Date: Dec. 4, 2003

(54) Tomato-Based products and process for preparing the same

(75) Inventors: Rodrigo de la Cuadra, Mexico City (MX); Colin Patrick Haine, Vlaardingen (NL); Gijsbert Kuil, Vlaardingen (NL); Gerard Liebrechts, Vlaardingen (NL); Angela Gaye Merrick, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/445,456

(22) Filed: May 27, 2003

(30) Foreign Application Priority Data
May 31, 2002 (EP) 02077154.9

(51) Int. Cl. A23K 1/00

(52) U.S. Cl. 426/615

(57) ABSTRACT

Tomato-based products having a thick consistency and a process for preparing the same. The process comprises the steps of hot- or cold breaking tomatoes, separating the resulting product into a product (a) rich in soluble tomato solids and water, and a product (b) rich in the insoluble tomato solids and water, optionally subjecting product (a) to a concentration step such that it is at least 10° Brix, and recombine product (a) and product (b) to a product (c) in such ratios that the resulting product has a ratio soluble tomato solids:insoluble tomato solids of between 1.0:0.5 and 1.0:20.

### FIELD OF THE INVENTION

The present invention relates to tomato-based products and a process for preparing the same. More in particular it relates to tomato-based products having a thick consistency and a process for preparing the same.

### BACKGROUND OF THE INVENTION

There is a wide range of food products that are tomato-based. For example: tomato juice, tomato soup, ketchup, pasta pour-over sauces, pizza toppings, tomato paste, etcetera. Conventionally, such products are made from an aseptic tomato concentrate or from freshly concentrated tomatoes.

The hot- and cold break process involving breaking the tomatoes (i.e. reducing in size, e.g. by cutting) and applying heat, either prior to, during, or after the breaking process. The amount of heat applied can be such that the product in the process reaches a temperature of above about 80-85° C., and the product is then generally called a hot break product. If the temperature does not exceed about 80-85° C. it is generally considered a cold break product. Hot break products have the advantage that enzymes (e.g. pectin-degrading enzymes) are inactivated quickly, thus giving a product that has a good (thick) consistency. However, the heating step is detrimental to flavours. The cold break process retains the fresh tomato flavours better, but enzymes are not fully or quickly inactivated, which may lead to broken down pectin, and as a consequence a thinner consistency. Depending upon the desired product, either the hot- or the cold break process may be used.

Tomato paste is (mainly) an intermediate product in tomato processing. It is spreadable product produced by finely comminuting a hot- or cold break product, which is concentrated, usually by evaporation. The concentration is usually such that tomato paste is about 24-31° Brix. The evaporation by heating has an influence on the product, e.g. on the texture and flavour profile. Although the product is highly concentrated and thus has a strong tomato flavour, it is a flavour with heat damage, in that some volatiles are lost, and a ‘cooked’ flavour may be present. Also, the flavour in tomato paste is perceived as too strong to be consumed without dilution for most applications. Also, the heating involved in the evaporative concentration affects the consistency, as the consistency is usually less than may be expected on the basis of the degree of concentration.

Tomatoes are usually harvested in a limited growing season (between 2-5 months), whilst demand for processed tomato products (e.g. ketchup, pasta sauces, etcetera) is year-round. Manufacturing capacity for formulating such products is limited therefore not all end-products can be prepared. Freshly harvested tomatoes are usually processed into concentrated tomato paste which is an intermediate product which can be stored. The concentrated tomato paste can serve as a base product for formulating end-products when there is demand and production capacity into a range of end-products, such as pasta sauces, ketchup, pizza toppings, juices, etcetera.

As tomato-based products have an increasing image of being a healthy food, and as tomato-based products are liked for their taste in many countries across the globe, there is an increasing demand for novel types of products based on tomato, having a good (i.e. thick) texture and a good flavour, preferably without the need for non-tomato thickeners such as starches and gums.

T. Tanglertpaibul et al disclose in Journal of Food Science, 52(2), pp 318-321 (1987) rheological properties of tomato concentrates prepared from juice of which the amount of pulp contents was increased or decreased by up to 30%.

U.S. Pat. No. 3,864,504 discloses a split stream process in which tomato (after pre-processing) is separated into a serum and a fibre steram, whereafter the serum is concentrated, and both streams are fully recombined. Similarly, U.S. Pat. No. 3,172,770 discloses a split stream process in which tomato (after pre-processing) is split in a fraction containing all insolubles and a fraction containing all solubles. The solubles-fraction was then concentrated and both fractions are fully recombined.

### SUMMARY OF THE INVENTION

It has now been found that a product comprising a tomato composition having a ratio soluble tomato solids:insoluble tomato solids of between about 1.0:0.5 and about 1.0:20 can have excellent properties for a wide range of applications. Such a product can have the consistency of conventional concentrated tomato paste (or even thicker), without the concentrated flavour. This makes it possible to have a tomato-based product having thick consistency, with good flavour, and without the need for additional (non-tomato) thickeners as gums and starches. In the products according to the invention it is preferred that the ratio soluble tomato solids:insoluble tomato solids is above about 1.0:0.7, more preferably above about 1.0:0.8, most preferred above about 1.0:1.0 or even above about 1.0:1.5. The upper limit of said ratio is preferably about 1.0:10, or above about 1.0:5.0. Thus, preferred ranges for the soluble tomato solids:insoluble tomato solids are e.g. about 1.0:0.7 to about 1.0:10, preferably about 1.0:0.8 to about 1.0:10. Most preferred ratios are between about 1.0:1.0 and about 1.0:5.0, or even about 1.0:1.5 to about 1.0:5.0.

The products according to the invention can suitably be prepared by a process for preparing a product comprising a tomato composition having a ratio soluble tomato solids:insoluble tomato solids of between about 1.0:0.5 and about 1.0:20 (or any of the other ranges disclosed above) which process comprises the steps of:

hot- or cold breaking tomatoes,

separating the resulting product into a product (a) rich in soluble tomato solids and a product (b) rich in the insoluble tomato solids,

subjecting product (a) to a concentration step such that it is at least about 10° Brix (preferably at least about 20° Brix, most preferred at least about 30° Brix),

recombine product (a) and product (b) to a product (c) in such ratios that the resulting product has a ratio soluble tomato solids:insoluble tomato solids of between about 1.0:0.5 and about 1.0:20 (or any other range of ratios as given above).

In the above process, it is preferred that after the hot or cold break process, the mixture is screened to remove seeds and/or skins.

In an alternative way to obtain the products as described above, the product (a) is not subjected to concentration, but used as such to blend a product having the desired ratio of soluble tomato solids: insoluble tomato solids. This would mean that a comparatively small amount of unconcentrated product (a) is mixed back with a comparatively large amount of product (b). Still, a product (c) can be obtained having the ratios as above disclosed, but the resulting product will contain more water, as there was no concentration step. It depends upon the desired end product whether this is an option.

Yet a further alternative way to obtain the products as described above is to effect only a partial removal of the fraction rich in sololuble solids from the hot- or cold break tomato to such an extent that the desired ratio solubles tomato solids:insoluble tomato solids is obtained, and leave the product as is. Like the previous alternative, the resulting product will contain more water, as no concentration step was employed.

### DETAILED DESCRIPTION OF THE INVENTION

Tomato compositions according to the above may be formulated into products like low-solids ketchup, which can be more economical to prepare than conventional ketchup, optionally without the need for additional thickeners like starch or gums. Another product which may be prepared using such tomato composition having the ratio soluble tomato solids:insoluble tomato solids as specified is a tomato spread which has a thick consistency similar to e.g. Mediterranean tapenades, with a mild, fresh tomato flavour. Yet many other product types are possible to formulate, which were difficult or impossible to achieve using conventional ingredients and/or processing. Even completely new products comprising tomato may also be designed which were not possible before, or only with a large amount of additional thickeners. Also, a new type thickeners based on tomato may be provided by the products according to the invention. The products according to the invention may optionally also be dried.

An object of the present invention was to provide products with a thick consistency, but with a flavour which is not overly concentrated and which is perceived with a similar intensity as tomatoes. In other words: aim was to prepare a tomato product in which the consistency is more concentrated than the flavour (compared to e.g. conventional paste where flavour is equally concentrated when compared with consistency). It was found that with the above formulations such could be achieved.

For comparison, the ratio of soluble tomato solids: insoluble tomato solids for conventional tomato products (i.e. not according to the invention) such as paste ranges from approximately 5:1 to 3:1. In principle, such ranges are for all conventional products the same, as conventional products have “natural” ratio's of soluble solids vs. insoluble solids, and differ e.g. in the degree water is removed. Data to this end are e.g. given in: http://www.ridgetownc.on.ca/research/sloewen/Reports/tomato02. pdf.

Page 28 of this report mentions a mean (taken fom 35 conventional processing varieties) soluble solids of 4.84 and a mean total solids of 6.12. The insoluble solids can be calculated from these numbers with the following formula:

IS=TS−SS/(1-SS/100).

This gives an IS of 1.35, and thus a ratio soluble tomato solids:insoluble tomato solids of approx. 4.84:1.35 equals approx. 3.6:1 (or 1:0.28).

W. P. Mohr (J. Inst. Can. Sci. Technol. Aliment. 9(3), pp 167-170, 1976) discloses SS and TS for 4 varieties of tomatoes for juice processing. TS is between 5.6 and 5.2, SS is between 4.5 and 4.6, and calculated IS are from 0.4-0.8. Resulting SS:IS ranges from 1:0.08 to 1:0.17.

In a product consisting only of tomatoes and optionally water, the amount of soluble solids equals the Brix value. As additions in formulated products like sugar, salt and starch influence the level of soluble solids and Brix, the ratios as mentioned herein are on soluble tomato solids (and insoluble tomato solids) and not on soluble solids and insoluble solids per se. In other words, for a formulated product the level of soluble tomato solids can be calculated by the level of Brix and correcting for non-tomato compounds that influence the level of total soluble solids. Such Brix value can be measured in a way known in the art of tomato processing, e.g. by a refractometer. A more detailed procedure is set out in the examples section.

The level of insoluble tomato solids can be measured by taking a sample and filtering/washing off the water and soluble compounds, and weighing the resulting dry product. Such product is mainly fibres, although similar to the measurement of the soluble tomato solids this has to be corrected for non-tomato insoluble solids. A more detailed procedure is set out in the examples section.

Depending upon the purpose of the resulting products, the desired extent of the separation into the thick stream (rich in insoluble tomato solids) and the thin stream (rich in soluble tomato solids) may be effected such that the thick stream (being rich in insoluble tomato solids) still contains a considerable amount of thin stream. This has the benefit that it still remains sufficiently liquid to handle.

Although the two split stream-produced tomato products thick stream and concentrated thin stream may be fully recombined to a paste with improved flavour and consistency, a key advantage of such split stream processing is that it gives additional advantages in product formulation, when the streams are only recombined in specific ratios, which are different from fully recombining the two streams. The present invention relates to products which are formulated by taking all of the thick stream and a reduced amount (or no at all) of the thin stream. Such products will have a thick consistency, whilst having a flavour profile that is such that the products can be consumed without dilution, as only a small or no amount at all of the concentrated, flavour-full thin stream is used.

It is preferred (for reasons of taste) that the product according to the invention further comprises from about 0.5-20%, preferably from about 0.8-10% of salt (i.e. dissolved soodium chloride or potassium chloride).

It is preferred that the products according to the invention as set out above further comprise at least about 0.5% (preferably about 2-50%) by weight of one or more component selected from the group consisting of: vegetable oil, aroma or flavouring compounds, onion, shallot, garlic, bell peppers, sweet bell peppers, chili peppers, courgette, egg plant, beet root, carrot, spinach, broccoli, tomato dices or chunks, fruit juices, fruit pastes, fruit particles, honey, herbs, spices (e.g. ground black or white or red or green pepper), sugar, nuts, seeds, cheese, cream, butter, egg white, egg yolk, starch, gums. Regarding the fruit (juices, paste and particles) one or more of apples, bananas, lemon, lime, grapefruit, orange or tropical fruit are preferred. Regarding the vegetable oil olive oil is preferred.

Product acording to the invention may be in the form of a ketchup, pasta sauce, pizza topping, garnishing sauce, mousse, jam, compote, vegetable spread, thickener, croquette, vegetable pastry filling, snack, or snack filling or other product. Such product type can be known, but the present invention can add a different texture and/or mouthfeel and/or taste. Such products can also be known for non-tomato origin, e.g. croquettes or jam. Also entirely new product types can be prpeared with the material which is presented with this invention.

In the split stream process as set out above, it is to be understood that the splitting into streams (a) and (b) is achieved such that most, preferably substantially all of the soluble tomato solids end up in (a) and that most, preferably substantially all of the insoluble tomato solids end up in (b). Such splitting can be effected e.g. by mechanical separators. Stream (a) is also called serum, or thin stream. Stream (b) is also called pulp, or thick stream. The thin stream that results of such split can suitably be concentrated to a high Brix value.

It is preferred to use standard processing varieties for the above processes and products, and not e.g. cherry tomatoes or wild-type tomatoes.

### EXAMPLES 1-5

Raw Materials

Tomatoes were subjected to a hot break process and the resulting product separated into two streams: one comprising mainly soluble tomato solids (“thin stream” in table below) and one comprising mainly insoluble tomato solids (and about 7% water, to keep the product pumpable, the “thick stream” in the table below). The amount of thin stream was about 85% (w/w) and thick stream was about 15% (w/w).

The splitting into a thick stream with mainly the insoluble tomato solids and the thin stream with mainly the soluble tomato solids were separated by mechanical separation. Subsequently, the thin stream (approx. 4-6° Brix) was concentrated using an evaporator as is known in tomato processing to yield approx. 30° Brix.

Various products were made with ingredients as are listed in table 1.

Method for Measuring Insoluble Solids (IS)

A 1-1.5g sample was weighed out to 4 decimal places between 4 pre-weighed filters (Whatman GFA 5.5 cm diameter). This was then placed on a Buchner vacuum filtration system and washed with 6 litres of de-ionised water. The filters were then dried in a vacuum oven at 70° C. for 1.5 hours and then cooled in a dessicator to room temperature. The filters were then re-weighed and insolubles solids calculated as the final weight minus initial filter weight, divided by the initial juice weight minus filter weight. Determination was carried out in triplicate.

Method for Measuring Serum Brix (SB) and Soluble Tomato Solids

A digital refractometer for example a Bellingham Stanley RFM 342 digital refractometer thermostatically controlled at 20° C. or a unit with equivalent specifications was used. The refractometer was calibrated with a range of 1-30% w/w sucrose in de-ionised water as standard solutions.

Enough sample was weighed into centrifuge tubes to provide a 1-2 ml liquid layer after centrifugation and centrifuged in a high speed centrifuge at 20° C. on a Beckman Optima TLX ultracentrifuge (TLA100.4 8-position fixed angle rotor) having the following gradient: 5,000/2 min., 20,000/2 min., 75,000/4 min., 100,000/10 min., 50,000/1 min., and end at 95,000 RPM +/−5000 RPM for 5 minutes to separate liquid from solid. The centrifugate liquid, was placed in a small vial and mixed gently.

The liquid was placed on the optic of a thermostatted refractometer, the lid closed and measured after the sample had sat for 30 seconds to reach the required temperature. The average of triplicate readings was calculated.

### Calculation of Total Solids (TS) over 100% of Product.

Total Solids (%)—Testing was conducted using a Labwave CEM. Samples above 15° Brix. were diluted to 15° Brix with distilled water. Samples at concentrations below 15° Brix were run undiluted. Two glass fibre pads were tared on the internal balance of the CEM. 3.0g-4.5g of the sample was spread on one of the glass fibre pads. The second glass fibre pad was then placed on top of the sample and pads put back onto the balance. The automatic program was started on the CEM which runs until a constant weight is achieved. The total solids (%) were then calculated. or

Total Solids (%)=((SB/100)*(100−IS))+IS

Calculation of Soluble Solids (SS) over 100% of product

Soluble Solids (%)=SB*(100−DM)/100−SB

For products with other solids than tomato solids: these either have to be removed, or the measured amounts of insoluble or soluble solids have to be corrected (if the amount is known) to arrive at soluble and insoluble tomato solids.

TABLE 1
examples with ingredients and ratio soluble
tomato solids: insoluble tomato solids

| | 1. | | 3. | | |
|---|---|---|---|---|---|
| | Tomato- | | Sweet | 4. | 5. |
| Ingredients | based | 2. | Tomato | Tomato | Tomato |
| (in % w/w) | spread | Ketchup | Sauce | croquettes | mousse |
| Thick stream | 70.6 | 30.0 | 54.3 | 89.7 | 24.0 |
| Thin stream | 4.7 | 6.0 | | | 3.7 |
| Sugar | | 19.0 | 11.6 | | 17.0 |
| Onion | 5.9 | | | 5.0 | |
| Gelatin | | | | | 1.1 |
| (dry leaves) | | | | | |
| Herbs & spices | 8.2 | 0.1 | | | |
| Potato powder | | | | 5.0 | |
| Salt | | 2.5 | | 0.3 | |
| Vinegar | | 6.8 | | | |
| Lemon juice | | | 2.3 | | |
| Cream | | | | | 46.3 |
| Olive oil | 10.6 | | | | |
| Water | | 35.6 | 31.8 | | 7.9 |
| Total | 100% | 100% | 100% | 100% | 100% |
| Ratio | 1.0:1.5 | 1.0:0.7 | 1.0:1.5 | 1.0:1.5 | 1.0:0.8 |
| soluble tomato | | | | | |
| solids:insoluble | | | | | |
| tomato solids | | | | | |

### Example 1

### Tomato-Based Spread

A tomato-based spread was prepared with thick- and thin stream as obtained using the process as set out above. To this end, the two streams were recombined in ratios as table 1 and combined with additional ingredients. The resulting products appeared as thick, spreadable masses, tomato-red, and with pleasant, not over-intensive tomato flavour.

### Example 2

### Ketchup

A ketchup was prepared by mixing the constituents in the amounts as given in table 1. Processing was using conventional equipment in tomato ketchup processing. The ketchup had good consistency.

### Example 3

### Sweet Tomato Sauce and Tomato Compote

The thick stream as obtained above was used with additional ingredients in the recipe given in table 1. All ingredients were combined in a pan and heated to the boil whilst stirring. The mixture was cooled down and kept refrigerated until serving. The product had a smooth, thick consistency with sweet/fresh tomato flavour.

For a compote-type product to the recipe above were added about 20% diced tomatoes.

### Example 4

### Tomato Croquettes

The thick stream as obtained above was used with additional ingredients in the recipe given in table 1. For coating was used: flour, breadcrumbs, egg. All ingredients as listed in the table were kneaded into a soft, plastic dough, and divided into portions and shaped into croquettes. The shaped portions were placed in a refrigerator for 10-15 minutes. Vegetable oil was heated to 180° C. in a deep-frying pan. Each shaped croquette was rolled in corn flour, egg and subsequent in bread crumbs, and fried in the hot oil. After frying excess oil was drained. The croquettes had good consistency and a pleasant tomato flavour.

### Example 5

### Tomato Mousse

The thin- and thick stream as obtained above were used with additional ingredients in the recipe given in table 1. Preparation: soak the gelatin leaves in small amount of water. Bring the water, with the lemon juice, tomato ingredients (thick and thin stream) 400 g of sugar to the boil. Squeeze the gelatin leaves, and add to tomato/sugar/water mixture and stir. Cool mixture down in cold water. Whip the cream with 50 gram of sugar until it is peaking. Gently mix-in the whipped cream in the cooled tomato mixture. Fill a pudding form and keep chilled for about 2 hours. Resulting product was a bavarois-type pudding with light, fresh tomato flavour.

1. Product comprising a tomato composition having a ratio soluble tomato solids:insoluble tomato solids of between about 1.0:0.5 and about 1.0:20.

2. Product according to claim 1, wherein said ratio soluble tomato solids:insoluble tomato solids is between about 1.0:0.7 and about 1.0:10.

3. Product according to claim 2, wherein said ratio soluble tomato solids:insoluble tomato solids is between about 1.0:1.0 and about 1.0:5.0.

4. Product according to claim 1, characterised in that it further comprises from about 0.5-20%, preferably from about 0.8-10% of salt.

5. Product according to claim 1, characterised in that it further comprises at least about 0.5% by weight of one or more additional components selected from the group consisting of: vegetable oil, aroma or flavouring compounds, onion, shallot, garlic, bell peppers, sweet bell peppers, chili peppers, courgette, egg plant, beet root, carrot, spinach, broccoli, tomato dices or chunks, fruit juices, fruit pastes, fruit particles, honey, herbs, spices, sugar, nuts, seeds, cheese, cream, butter, egg white, egg yolk, starch, gums.

6. Product according to claim 5, wherein said percentage of additional components is about 2-50% (w/w).

7. Product according to claim 5, wherein the fruit juices or -paste or -particles comprise one or more of apples, bananas, lemon, lime, grapefruit, orange or tropical fruit.

8. Product according to claim 5, wherein the vegetable oil is olive oil.

9. Product acording to claim 1 or 5, which is a ketchup, pasta sauce, pizza topping, garnishing sauce, mousse, jam, compote, vegetable spread, thickener, croquette, vegetable pastry filling, snack, or snack filling.

10. Process for preparing a product comprising a tomato composition having a ratio soluble tomato solids:insoluble tomato solids of about 1.0:0.5 and about 1.0:20 which process comprises the steps of:
hot- or cold breaking tomatoes,
separating the resulting product into a product (a) rich in soluble tomato solids and water, and a product (b) rich in the insoluble tomato solids and water,
subjecting product (a) to a concentration step such that it is at least about 10° Brix
recombine product (a) and product (b) to a product (c) in such ratios that the resulting product has a ratio soluble tomato solids:insoluble tomato solids of between about 1.0:0.5 and about 1.0:20.

11. Process for preparing a product comprising a tomato composition having a ratio soluble tomato solids:insoluble tomato solids of about 1.0:0.5 and about 1.0:20 which process comprises the steps of:
hot- or cold breaking tomatoes,
separating the resulting product into a product (a) rich in soluble tomato solids and water, and a product (b) rich in the insoluble tomato solids and water,
recombine product (a) and product (b) to a product (c) in such ratios that the resulting product has a ratio soluble tomato solids:insoluble tomato solids of between about 1.0:0.5 and about 1.0:20.

12. Process for preparing a product comprising a tomato composition having a ratio soluble tomato solids:insoluble tomato solids of about 1.0:0.5 and about 1.0:20 which process comprises the steps of:
hot- or cold breaking tomatoes,
removing partially the fraction rich in soluble solids from the hot- or cold break tomato, such ratios that the resulting product (c) has a ratio soluble tomato solids:insoluble tomato solids of between about 1.0:0.5 and about 1.0:20.

13. Process according to claim 10-12, wherein to any of products (a), (b), or (c) is added one or more of: vegetable oil, aroma or flavouring compounds, onion, shallot, garlic, peppers, courgette, egg plant, beet root, carrot, spinach, broccoli, tomato dices or chunks, fruit juices, fruit pastes, fruit particles, honey, herbs, spices (e.g. pepper), salt, sugar, nuts, seeds, cheese, cream, butter, egg white, egg yolk, starch, gums.
